(19) United States
(12) Patent Application Publication
(10) Pub. No.: US 2008/0199578 A1
(43) Pub. Date: Aug. 21, 2008

(54) Fish Packing System

(75) Inventor: Pedro Cavicchioli, Santiago (CL)

Correspondence Address: FOLEY HOAG, LLP;PATENT GROUP, WORLD TRADE CENTER WEST, 155 SEAPORT BLVD, BOSTON, MA, 02110, US

(73) Assignee: Saam Servicios A La Industria Hidrobiologica Limitada, Santiago (CL)

(21) Appl. No.: 12/033,550

(22) Filed: Feb. 19, 2008

(30) Foreign Application Priority Data
Feb. 19, 2007 (CL) 451-2007

(51) Int. Cl. A23B 4/08; B65B 31/00; B65B 55/00

(52) U.S. Cl. 426/393

(57) ABSTRACT

The present invention relates to a procedure for packaging a product comprising pieces of fresh fish meat, in shipments that retain a mixture of gases to create a modified atmosphere (MAP), wherein said procedure allows transportation of the product in cold storage lockers for prolonged periods. In some embodiments, the fresh fish is salmonid, and in other embodiments, the fresh fish is salmon.

### RELATED APPLICATIONS

This application claims priority under 35 U.S.C. § 119 to Chilean Patent Application No. 451-2007, filed Feb. 19, 2007, which is hereby incorporated by reference in its entirety.

### BACKGROUND OF THE INVENTION

Several packaging procedures are known for red meat, poultry, and fish that use Modified Atmospheric Packaging (MAP). However, the majority of these procedures focus on individual packages, in order to be available for the end consumer at points of sale, which imposes certain restrictions that are different from the restrictions of this procedure.

Some of these restrictions of the previous art based on MAP systems are, among others:
Packaged with a volumetric fish:gas rate on the order of 1:3, which results in high storage and transportation costs, since they occupy volumes 2 or 3 times greater than those occupied by other packaging methods;
The product shelf life is insufficient to tolerate several days in transport, such as by ocean or land freight throughout lengthy time frames, and insufficient for tolerating the delays inherent in distribution to points of sale, even when the product is kept in cold storage lockers.

Among the procedures of the previous art that rely on Modified Atmosphere Packing, many endeavor to make innovations in the composition of the gas mixture and in packaging features with the object of lengthening the shelf life of the product and avoiding gas leakage which they must contain; or introduce variations in the packing process for the purpose of preserving the color of red meats. However, we have not detected procedures that satisfactorily prolong the time that fish meat remains fresh—when packed in high density packaging—for time periods long enough to be able to supply remote markets, when they are maintained at temperatures close to 0° C., following the steps which are used in the procedure of this invention.

Due to the demands of the market it is desirable that salmonid meat—such as that of the salmon—be provided fresh without having been frozen, to maintain the structure of its tissues. Currently salmon meat is mainly marketed in the form of fillets that include the skin. This final demand of the market makes it even more difficult that the product to be transported endure long transportation times, even in cold storage lockers and in modified atmosphere packaging, due to the fact that the skin adhered to the fillet includes its scales and its own mucosal tissues, which defines a surface that tends to accumulate undesirable microorganisms which shorten the shelf life of the product.

### SUMMARY OF THE INVENTION

One aspect of the invention relates to a procedure for packaging a product comprising fresh fish meat, preferably salmonid, in shipments that retain a mixture of gases to create a modified atmosphere (MAP), wherein said procedure allows transportation of the product in cold storage lockers for prolonged periods.

In one embodiment, the present invention relates to a procedure for packaging a product comprising fresh fish meat, in shipments that retain a mixture of gases to create a modified atmosphere, wherein said procedure allows transportation of the product in cold storage lockers for prolonged periods, comprising the following steps:
a) maintaining fish pieces or fillets at a temperature ranging between about −1° and 0° C.;
b) placing said fish pieces or fillets in grated trays or similar trays and distributing them to expose a substantial portion of their surface area, preferably to provide the greatest exposure of their surface area;
c) sanitizing said pieces with a food grade microbicidal product; wherein said pieces may later be drained;
d) individually wrapping or bagging of said pieces with a laminar material, wherein the laminar material may be significantly permeable to said gas mixture and significantly impermeable to liquid water;
e) packing, for example in a sealable package, more than one said pre-wrapped or pre-bagged pieces in said laminar material; the sealable package being made of a material significantly impermeable to said gas mix, forming in this way a modified atmosphere package;
f) filling said sealable package with a modified atmospheric packaging (MAP) gas mix, that replaces the air it contains; wherein in some embodiments, said MAP gas mix comprises carbon dioxide (CO₂) in an amount ranging between about 70 and 95% v/v, no more than about 0.5% v/v oxygen, and the rest of said gaseous MAP mix is mainly nitrogen with traces of other residual gases; the fish:gas volumetric ratio is between about 0.7 and 0.9; and
g) sealing of said sealable package, in which there is a refrigeration stage, at a temperature of about −1.5° C., of said set of fish pieces which may be carried out at any point of the procedure, after sanitization up to sealing of the sealable package.

In some embodiments, the fish meat comprises salmonid meat.

In some embodiments, the fresh fish meat, which may be salmonid meat, comprises at least part of its skin and scales.

In some embodiments, if during step (b) any batch of said fish pieces attains a temperature no more than about 2° C. above said pre-processing temperature, ranging between about −1° C. and 0° C., said batch is diverted to a cooling stage so that the temperature may be adjusted to fall within said range.

In some embodiments, the microbicide is of a weak acidic type, with antioxidant properties. In other embodiments, said microbicide is the commercial product CITREX®, or the commercial product BIOCITROL®.

In some embodiments, the microbicide is applied as an aqueous solution preferably at a concentration of about 400 ppm, at a temperature between about −1.0° C. and 0° C. for about 30 seconds.

In some embodiments, the microbicide is applied as a spray, while in other embodiments, the microbicide is applied by immersion.

In some embodiments, the laminar material of step (d) is chosen from among high density polyethylenes and low density polyethylenes.

In some embodiments, the sealable package of step (e) is placed in a box that is relatively rigid. In some embodiments, the sealable package of said step (e) is selected from the group consisting of high density polyethylenes, low density polyethylenes, and polylaminates. The sealable package may be resistant to temperatures ranging from between about 25 and −5° C.

In some embodiments, the amount of carbon dioxide in said MAP gas mix of step (f) is about 87% v/v.

In some embodiments, the aforementioned procedure for packaging of a product comprising fresh fish meat is carried out at an ambient temperature no greater than about 4° C. during a period of no more than about 30 minutes.

### BRIEF DESCRIPTION OF THE DRAWINGS

FIG. 1 is a diagram, using squares, of a preferred embodiment of this invention.

### DETAILED DESCRIPTION OF THE INVENTION

Generally speaking, this invention relates to a procedure for packaging fresh fish meat, which allows for transporting it in cold storage lockers for prolonged periods. More in particular, the preferred modality for the procedure of this invention is applicable to packaging of unfrozen salmon meat in boxes containing bags that retain a modified atmosphere and with the fish product having been specially treated, which allows for its transport in cold storage lockers for a period sufficient to be able to use ocean going freighter.

It is known that managing the temperature is especially necessary because it significantly affects the speed in which the meat undergoes the spoiling process. This procedure allows the avoidance of temperature abuse and allows the product to remain packed in the conditions desired by significantly reducing breaks in the cold chain, forgoing the use of gel packs which are not very effective and that are currently used in the industry.

The procedure of this invention is applicable to packaging salmon fillets (although not limited to this use) that include part of its skin with its scales, without having to turn to packaging that is as costly and voluminous as those used in the previous art, while at the same time allowing for product conservation times which are significantly greater than those achieved up to now.

In very general terms, the procedure of this invention includes the reception of the salmonid pieces or fillets together with part of its skin, which have been processed and kept at an external low temperature, but which have not been frozen. The process is carried out in no more than 30 minutes, at an ambient temperature no greater than 4° C. while observing the prevailing standards for food handling, to insure proper asepsis of the product to be packaged and transported. The fillet pieces are submitted to sanitizing using a food grade microbicide, by spraying or immersion. After draining off the excess sanitizer, the pieces are wrapped and put into bags made of a material that acts as a mechanical barrier, yet is permeable to the gases of the modified atmosphere and impermeable to liquid water, which serves to insulate one piece from another when they are piled up or placed close to each other. A group of pieces wrapped in this manner are placed in a sealable package, which is extremely impermeable to the gas mix, where air is substituted for a gaseous mix mainly made up of carbon dioxide (CO₂), and a lesser amount of oxygen, with the rest being mainly nitrogen and traces of other residual gases. The bags used as a mechanical barrier and the sealable bag are submitted to a sanitizing pre-process to reduce the possible causes of microbial contamination of the product. Preferably, the sealed bag is placed into a package, which is then closed, giving it greater rigidity and facilitating stacking, which is appropriate for its transportation and distribution. After applying the modified atmosphere and sealing the package which contains it together with the various individually wrapped pieces of fillet, the packages containing the product are refrigerated at 1.5° C., now ready to be transported into cold storage lockers that must maintain this temperature.

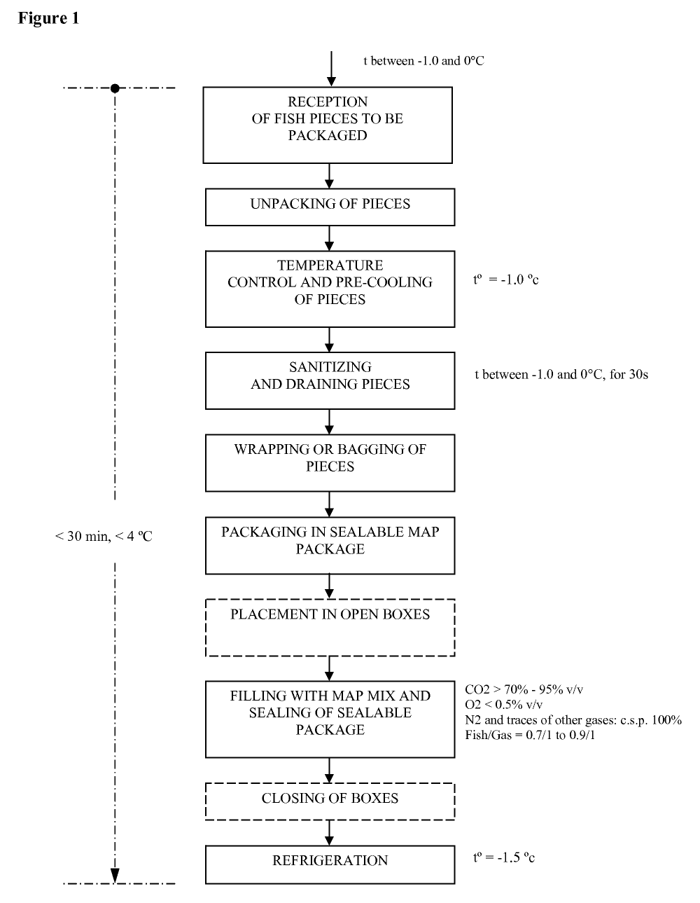

To better understand the procedure of the invention, it will be described with the support of the drawings, which show a preferred, but not restrictive, embodiment of the invention. As is shown in FIG. 1, the method of this invention begins with the reception of the salmonid pieces or fillets that, preferably, keep part of its skin and scales. Due to the fact that we are dealing with a perishable product, the success of the method of the invention is not independent from the prior fish handling conditions, from its capture up until its entry into the final processing line, which makes it preferable that the pieces received be pre-processed (transportation from capture, gutting, and filleting, and transportation to the final processing plant), closely adhering to food handling standards, to ensure proper asepsis of the product to be packaged and transported. The temperature of the pre-processed raw material should be kept between −1 and 0° C. before submitting it to Modified Atmosphere Packaging. If any batch of the pieces or fillets exceeds the pre-processing temperature by no more than 2° C., it is diverted to a cooling stage so that the above defined parameters may be adjusted. If the temperature of the batch exceeds the 2° C., the batch is discarded.

The entire process of this invention is carried out in no more than 30 minutes, at an ambient temperature no greater than 4° C.

The pieces of fillet are extracted from the packaging in which they are received from the capture and preprocessing centers, to be put in grated trays, being careful to avoid contact of each piece with its neighboring pieces, so as to leave the majority of its surface exposed, which will be submitted to sanitization with a food grade germicide product, through spraying or submersion. Preferably, a sanitizing agent of the weak acid type will be used, that has antioxidant properties, such as CITREX® or BIOCITROL®, applied as an aqueous solution preferably with a concentration of 400 ppm, which will be applied at a temperature between −1.0° C. and 0° C. for 30 seconds.

After sanitizing, the pieces are drained and each is wrapped in sheets of a mechanical barrier, which may be bags that are significantly permeable to the MAP gas mix and significantly impermeable to liquid water. This stage is carried out to provide a mechanical barrier between each piece, to avoid that the skin of one contacts the meat of others, since, in spite of being sanitized, active and latent microorganisms will still remain in the interstitial space between the scales and on rough areas of uncovered meat. The material of the mechanical barrier is gas permeable and any material may be used that is appropriate to said permeability conditions, preferably using high and low density polyethylene.

The individually wrapped pieces of fillet with the mechanical barrier sheet are placed in a hermetically sealable package, preferably a bag, made of a material that is significantly impermeable to the MAP gas mix, which preferably, is put into a box that is relatively rigid. Once one or two layers of fillet pieces are placed in the sealable package, the air is replaced with a gaseous mix made up of mainly carbon dioxide (CO₂) and nitrogen.

The content of the carbon dioxide in the gaseous mix is between 70 and 95% v/v, preferably 87%, not more than 0.5% oxygen, with the rest of the gaseous mix of nitrogen and traces of other residual gases. The fish:gas volumetric ratio is between 0.7 and 0.9.

Surprisingly, it has been proven that, in the conditions of this procedure, the elevated concentrations of carbon dioxide used do not cause negative effects on the quality of the product cited in the literature.

The material of the sealable package may be any of those usually used in the art prior for MAP, such as high or low density polyethylene, and poly laminates resistant to temperatures between 25 and −5° C., among others.

In one example of implementation of this method, the sealable package's material was chosen with a thickness that would not allow a loss of carbon dioxide of more than 200 cm³/day/m², and the entrance of oxygen no greater than 70 cm³/day/m², assuming a difference in partial pressure of 1 atmosphere of CO₂, and of O₂, and when applicable, to 2° C., and 0% relative humidity. After 15 days, the content of O₂ increased to values between 1 and 5% and the CO₂ fell to levels ranging between 35 and 55%, which was satisfactory from the point of view of prevention of favorable conditions for the growth of anaerobic pathogens, in a stage close to the distribution of the product, which is when undesirable elevations in the temperature might occur.

Finally, the packages are refrigerated at 1.5° C., and are ready to be transported in cold storage lockers that must maintain this temperature until arrival at the points of distribution to the end consumer. Alternately, refrigeration at −1.5° C. may be carried out as a pre-stage to the MAP packing.

Through the procedure of this invention conservation times for salmon fillets of over 20 days are obtained, which is significantly higher than the duration of packaged pieces using the techniques of the prior art that use modified atmosphere, the duration of which tend to be less than 10 days. This significant lengthening of the duration of the unfrozen product allows a great reduction in transportation costs, because the products may thus tolerate prolonged voyages, such as are required by ocean going freighters, of less cost per volume than that of other faster transportation methods, such as air transport.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A procedure for packaging a product comprising fresh fish meat, in shipments that retain a mixture of gases to create a modified atmosphere, wherein said procedure allows transportation of the product in cold storage lockers for prolonged periods, comprising the following steps:
a) maintaining fish pieces or fillets at a temperature ranging between about −1° and 0° C.;
b) placing said fish pieces or fillets in trays and distributing them to expose a substantial portion of their surface area;
c) sanitizing said pieces with a food grade microbicidal product;
d) individually wrapping or bagging of said pieces with a laminar material which is significantly permeable to said gas mixture and significantly impermeable to liquid water;
e) packing, in a sealable package, of more than one said pre-wrapped or pre-bagged pieces in said laminar material; the sealable package being made of a material significantly impermeable to said gas mix, forming in this way a modified atmosphere package;
f) filling said sealable package with a modified atmospheric packaging (MAP) gas mix, that replaces the air it contains; wherein said MAP gas mix comprises carbon dioxide (CO₂) in an amount ranging between about 70 and 95% v/v, no more than about 0.5% v/v oxygen, and the rest of said gaseous MAP mix is mainly nitrogen with traces of other residual gases; the fish:gas volumetric ratio is between about 0.7 and 0.9; and
g) sealing of said sealable package, in which there is a refrigeration stage, at a temperature of about −1.5° C., of said set of fish pieces which may be carried out at any point of the procedure, after sanitization up to sealing of the sealable package.

2. The procedure for packaging of a product comprising fresh fish meat, defined in claim 1, wherein the fish meat comprises salmonid meat.

3. The procedure for packaging of a product comprising fresh fish meat, defined in claim 1 or 2, wherein the said fish meat retains part of its skin and scales.

4. The procedure for packaging of a product comprising fresh fish meat, defined by any of the claims between 1 and 3, wherein if during step (b) any batch of said fish pieces attains a temperature no more than 2° C. above said pre-processing temperature, ranging between −1° C. and 0° C., said batch is diverted to a cooling stage so that the temperature may be adjusted to fall within said range.

5. The procedure for packaging of a product comprising fresh fish meat, defined in any of claims 1 to 4, wherein said microbicide is of a weak acidic type, with antioxidant properties.

6. The procedure for packaging of a product comprising fresh fish meat, defined in claim 5, wherein said microbicide is the commercial product CITREX®.

7. The procedure for packaging of a product comprising fresh fish meat, defined in claim 5, wherein that said microbicide is the commercial product BIOCITROL®.

8. The procedure for packaging of a product comprising fresh fish meat, defined in any of claims 5 to 7, wherein said microbicide is applied as an aqueous solution preferably at a concentration of about 400 ppm, at a temperature between about −1.0° C. and 0° C. for about 30 seconds.

9. The procedure for packaging of a product comprising fresh fish meat, defined in any of claims 5 to 8, wherein said microbicide is applied as a spray.

10. The procedure for packaging of a product comprising fresh fish meat, defined in any of claims 5 to 8, wherein said microbicide is applied by immersion.

11. The procedure for packaging of a product comprising fresh fish meat, defined in any of claims 1 to 10, wherein said laminar material of said step (d) is chosen from among high density polyethylenes and low density polyethylenes.

12. The procedure for packaging of a product comprising fresh fish meat, defined in any of claims 1 to 11, wherein said sealable package of said step (e) is placed in a box that is relatively rigid.

13. The procedure for packaging of a product comprising fresh fish meat, defined in any of claims 1 to 12, wherein said sealable package of said step (e) is chosen from among high density polyethylenes, low density polyethylenes, and polylaminates, resistant to temperatures ranging from between about 25 and −5° C.

14. The procedure for packaging of a product comprising fresh fish meat, defined in any of claims 1 to 13, wherein the amount of carbon dioxide in said MAP gas mix of step (f) is about 87% v/v.

15. The procedure for packaging of a product comprising fresh fish meat, defined in claim 1, wherein the trays are grated trays.

16. The procedure for packaging of a product comprising fresh fish meat, defined in claim 1, wherein step (c) further comprising draining said pieces after sanitizing.

17. The procedure for packaging of a product comprising fresh fish meat, defined in claim 1, wherein said procedure is carried out at an ambient temperature no greater than about 4° C. during a period of no more than about 30 minutes.
